(19) United States
(12) Patent Application Publication
(10) Pub. No.: US 2007/0279648 A1
(43) Pub. Date: Dec. 6, 2007

(54) System and method for automatically resizing electronic documents

(75) Inventors: Tony Quach, Anaheim, CA (US); Sheng Lee, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/444,586

(22) Filed: Jun. 1, 2006

(51) Int. Cl. G06K 15/02

(52) U.S. Cl. 358/1.2

(57) ABSTRACT

A system and method for automatically resizing electronic documents based upon the original document page settings and the region of the outputting document rendering device. An electronic document is first received for output by an associated document rendering device. After receipt of the electronic document, the document rendering device retrieves its regional data. The regional data is used to determine the regional paper sizes available for outputting documents. Based on the retrieved regional data and the original output size of the electronic document, a determination is made as to the appropriate available output paper size. The electronic document is then resized, corresponding available output paper size, and rendered, without requiring user intervention.

### BACKGROUND OF THE INVENTION

This invention is directed to a system and method for automatically resizing electronic documents. More particularly, this invention is directed to a system and method for detecting the country or region code setting of a document rendering device and automatically converting the requested output or paper size of the document processing job to the available output size for the region or country.

As documents are transmitted between various countries or regions, oftentimes the output or page size of the document rendering device is incompatible with the size of the original image. For example, a user in the United States would typically generate an electronic document having an American National Standards Institute (ANSI) output size, such as legal size documents. If such user were to transmit the electronic document to another user in a region or country in which electronic documents are typically generated using International Standards Organization (ISO) output size, such as A4, the user in the ISO region may encounter difficulties in rendering the electronic document. The document rendering device used by the user in the ISO region may not be able to correctly convert the electronic document having an ANSI output size to an ISO output size. The user in the ISO region may have to manually convert or format the electronic document in order for the document to be rendered correctly by the document rendering device. As such, there is a need for document rendering system and method for automatically resizing electronic documents based on the country or region code setting of the document rendering device used to render the electronic document.

The subject application overcomes the above-noted limitations and provides a system and method for detecting the country or region code setting of a document rendering device and automatically converting the requested output size of the document processing job to the available output size for the region or country.

### SUMMARY OF THE INVENTION

In accordance with the subject application, there is provided a system and method for automatically resizing electronic documents.

Further, in accordance with the subject application, there is provided a system and method for detecting the country or region code setting of a document rendering device and automatically converting the requested output size of the document processing job to the available output size for the region or country.

Still further, in accordance with the subject application, there is provided a method for automatically resizing an electronic document. The method comprises the steps of receiving an electronic document and testing region data representative of regional document output characteristics of an associated document rendering device. The method then determines an output size specified with a received electronic document. The received electronic document is then altered in accordance with tested region data and a determined output size so as to generate an output document and communicated to the associated document rendering device. Preferably, the region data is at least one of ISO and ANSI.

In one embodiment of the subject application, the step of selectively altering includes altering the received electronic document to reflect an output size corresponding to the region data and which approximates the output size.

In another embodiment of the subject application, the method further comprises the step of determining whether the print size corresponds to the region data, wherein an output document is unchanged from a received electronic document upon a determination of such correspondence.

In accordance with another aspect of the subject application, there is provided a system for automatically resizing electronic documents. The system includes means adapted for receiving an electronic document and testing means adapted for testing region data representative of regional document output characteristics of an associated document rendering device. The system further comprises determination means adapted for determining an output size specified with a received electronic document. The system also comprises means adapted for selectively altering the received electronic document in accordance with tested region data and a determined output size so as to generate an output document and communication means adapted for communicating the generated output document to the associated document rendering device.

In another embodiment of the subject application, means adapted for selectively altering the received electronic document includes means adapted for altering the received electronic document to reflect an output size corresponding to the region data and which approximates the output size.

In another embodiment of the subject application, the system further comprises means adapted for determining whether the print size corresponds to the region data, wherein an output document is unchanged from a received electronic document upon a determination of such correspondence.

Still other objects and aspects of the subject application will become readily apparent to those skilled in this art from the following description wherein there is shown and described a preferred embodiment of this invention, simply by way of illustration of one of the best modes suited to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the subject application, and together with the description serve to explain the principles of the invention. In the drawings:

FIG. 1 is a block diagram of the system for automatically resizing electronic documents according to the subject application;

FIG. 2 is block diagram illustrating controller hardware for use in the system for automatically resizing electronic documents according to the subject application;

FIG. 3 is a functional block diagram illustrating the controller for use in the system for automatically resizing electronic documents according to the subject application; and

FIG. 4 is a flowchart illustrating a method for automatically resizing electronic documents according to the subject application.

### DETAILED DESCRIPTION OF THE PREFERRED EMBODIMENT

This invention is directed to a system and method for automatically resizing electronic documents. More particularly, the subject application is directed to a system and method for detecting the country or region code setting of a document rendering device and automatically converting the requested output size of the document processing job to the available output size for the region or country. Preferably, the document rendering device is a multifunctional peripheral device, capable of providing scanning, copying, facsimile, printing, document management, document storage, electronic mail, and other document processing functions to a user.

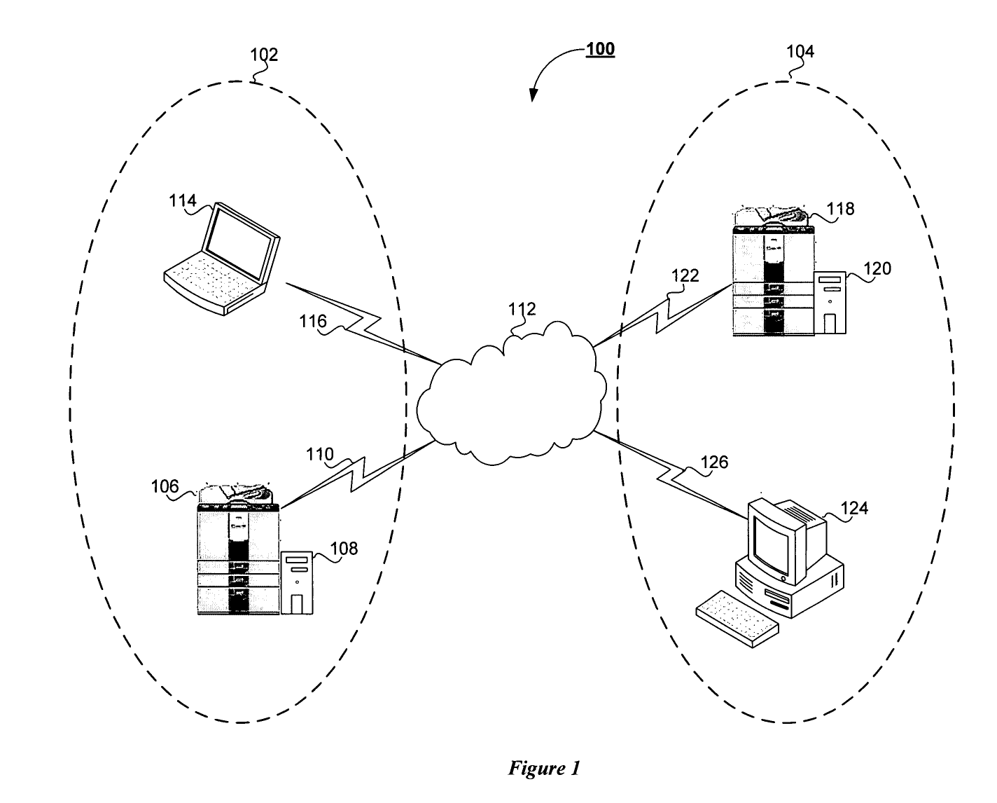

Referring now to FIG. 1, there is shown a block diagram illustrating a system 100 in accordance with the subject application. The system 100 includes two regions, an American National Standards Institute (ANSI) region 102 and an International Standards Organization (ISO) region 104. It will be appreciated by those skilled in the art that the two regions 102, 104 are capable of representing two distinct countries, each country subscribing to a different output medium standard. Furthermore, the skilled artisan will appreciate that while ANSI and ISO are used, these are representative only, and other standards, paper sizes, or country codes are equally capable of being employed in accordance with the subject application. As illustrated in FIG. 1, the ANSI region 102 includes a document rendering device 106, a controller 108 communicatively coupled to the document rendering device 106, and a client device 114. It will be appreciated by those skilled in the art the document rendering device 106 is advantageously represented in FIG. 1 as a multifunction peripheral device, suitably adapted to provide a variety of document processing services, such as, for example and without limitation, electronic mail, scanning, copying, facsimile, document management, printing, and the like. Suitable commercially available document rendering devices include, but are not limited to, the Toshiba e-Studio Series Controller. In one embodiment, the document rendering device 106 is suitably equipped to receive a plurality of portable storage media, including without limitation, Firewire drive, USB drive, SD, MMC, XD, Compact Flash, Memory Stick, and the like.

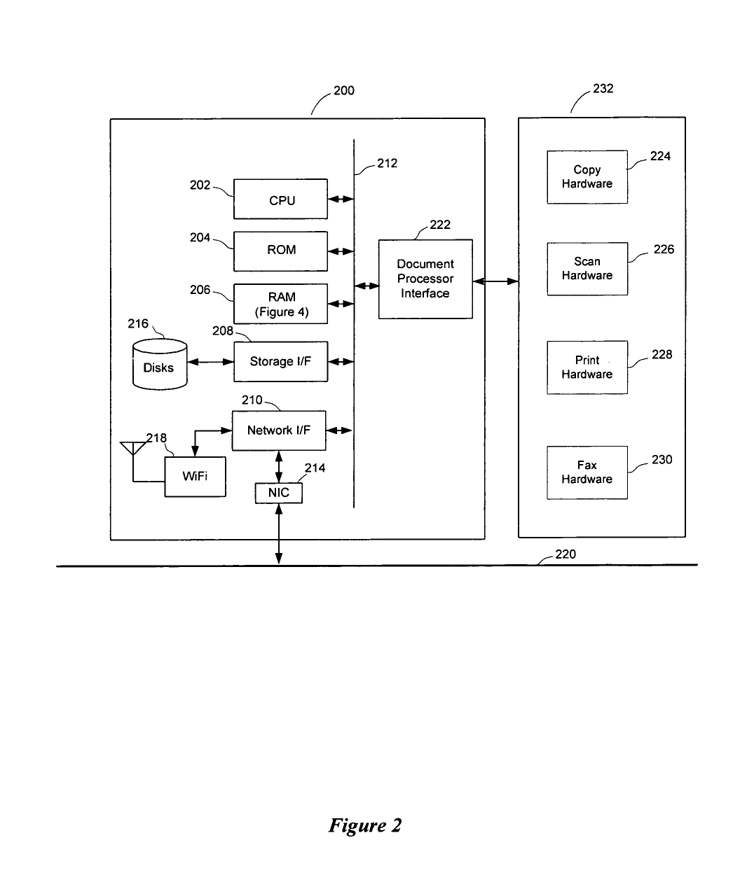

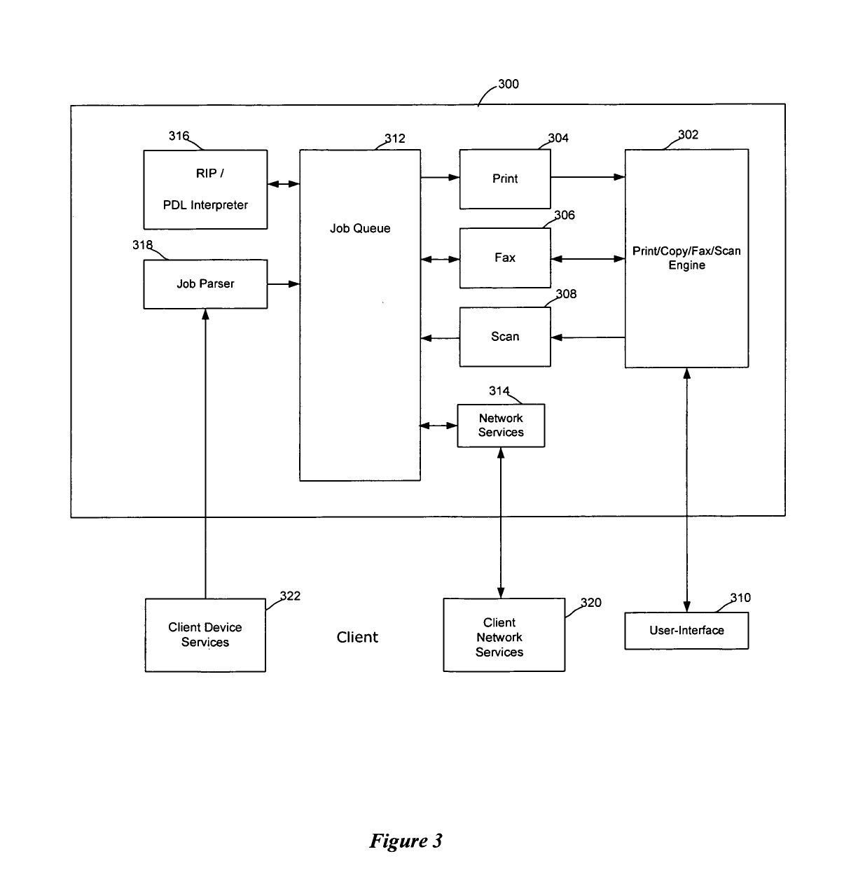

The controller 108 included in the system 100 is in data communication with the document rendering device 106. It will be understood by those skilled in the art that the controller 108 is any hardware, software, or combination thereof, suitably adapted to facilitate the control of the document rendering device 106. The functioning of the controller 108 will better be understood in conjunction with the block diagrams illustrated in FIGS. 2 and 3, explained in greater detail below. It will further be appreciated by those skilled in the art that such control is advantageously exercised over various hardware and software components of the document rendering device 106, including, for example and without limitation, modems, network interface components, printer engines, copier components, facsimile components, optical character recognition, and the like.

The ANSI region 102 further includes the client device 114. It will be appreciated by those skilled in the art that the client device 114 is depicted in FIG. 1 as a laptop computer for illustration purposes only. As the skilled artisan will understand, the client device 114 shown in FIG. 1 is representative of any personal computing device known in the art, including, for example and without limitation, a personal computer, a personal data assistant, a web-enabled cellular telephone, a smart phone, or other web-enabled electronic device suitably capable of generating and/or transmitting electronic document data to a multifunctional peripheral device.

In the preferred embodiment, the document rendering device 106 of the ANSI region 102 is communicatively coupled to a distributed communications environment, illustrated in FIG. 1 as the Internet 112. The skilled artisan will understand that any distributed communications environment is equally capable of being employed in accordance with the subject application. For example and without limitation, when employing a facsimile based transmission of an electronic document, the document rendering device 106 communicates via the public switched telephone network. Other examples include a local area network, a wide area network, and the like. Communication between the distributed communications network 112 and the document rendering device 106 is advantageously accomplished via a communications link 110. The communications link 110 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

The ANSI region 102 client device 114 is also communicatively coupled to the distributed communications environment 112 via a suitable communications link 116. As previously discussed, a suitable communications link 116 employed in accordance with the subject application includes, WiMax, 802.11a, 802.11b, 802.11g, 802.11(x), Bluetooth, the public switched telephone network, a proprietary communications network, infrared, optical, or any other suitable wired or wireless data transmission communications known in the art. In the preferred embodiment, the client device 114 is suitably adapted to generate an electronic document using any document or image generating application known in the art.

Similar to ANSI region 102, the ISO region 104 includes a document rendering device 118, a controller 120 communicatively coupled to the document rendering device 118, and a client device 124. As will be appreciated by those skilled in the art, the document rendering device 118 is represented in FIG. 1 as a multifunction peripheral device, suitably adapted to provide document processing services to a user, including, for example and without limitation, printing, scanning, facsimile, copying, document management, electronic mail, and the like. Suitable commercially available document rendering devices include, but are not limited to, the Toshiba e-Studio Series Controller. In one particular embodiment, the document rendering device 118 includes hardware and software suitably adapted to receive portable storage media, including, for example and without limitation, SD, XD, Memory Stick, MMC, USB drive, Firewire drive, and the like.

The communicatively coupled controller 120 is any hardware, software, or combination thereof, suitably adapted to facilitate the control of the document rendering device 118. Preferably, the controller 120 is embodied as hardware, software, or any suitable combination thereof, configured to control the operations of the associated document processing device 118, control the display of images via the user-interface, and the like. The functioning of the controller 120 will better be understood in conjunction with the block diagrams illustrated in FIGS. 2 and 3, explained in greater detail below. The skilled artisan will appreciate that the control exerted by the controller 120 over the document rendering device 118 includes control over various software and hardware components, such as, for example and without limitation, modems, network interface components, printer engines, copier components, facsimile components, optical character recognition, and the like. It will be appreciated by those skilled in the art that the client device 124 of the ISO region 104 is depicted in FIG. 1 as a desktop personal computer for illustration purposes only. As the skilled artisan will understand, the client device 124 shown in FIG. 1 is representative of any personal computing device known in the art, including, for example and without limitation, a laptop computer, a smart phone, a web-enabled cellular telephone, a personal data assistant, or other web-enabled electronic device suitably capable of generating and/or transmitting electronic document data to a multifunctional peripheral device.

As with the document rendering device 106 of the ANSI region 102, the document rendering device 118 of the ISO region 104 is communicatively coupled to the distributed communications environment 112 via a suitable communications link 122. The communications link 122 is any suitable channel of data communications known in the art including, but not limited to wireless communications, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

The ISO region 104 client device 124 is also communicatively coupled to the distributed communications environment 112 via a suitable communications link 126. As previously discussed, a suitable communications link 126 employed in accordance with the subject application includes, Bluetooth, WiMax, 802.11a, 802.11b, 802.11g, 802.11(x), a proprietary communications network, infrared, optical, the public switched telephone network, or any suitable wireless data transmission system, or wired communications known in the art. In the preferred embodiment, the client device 124 is suitably adapted to generate an electronic document using any document or image generating application known in the art.

Turning now to FIG. 2, illustrated is a representative architecture of a suitable controller 200, e.g., the controller 108 and the controller 120 of FIG. 1, on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, e.g., document processing device 106 and document processing device 118, that include the controller.200 of FIG. 2 as an intelligent subsystem associated with the document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably via an interface local to the controller, or remotely via a remote thin or thick client.

The engine 302 is in data communication with printer function 304, facsimile function 306, and scan function 308. These devices facilitate the actual operation of printing, facsimile transmission and reception, and document scanning for use in securing document images for copying or generating electronic versions.

A job queue 312 is suitably in data communication with printer function 304, facsimile function 306, and scan function 308. It will be appreciated that various image forms, such as bit map, page description language or vector format, and the like, are suitably relayed from scan function 308 for subsequent handling via job queue 312.

The job queue 312 is also in data communication with network services 314. In a preferred embodiment, job control, status data, or electronic document data is exchanged between job queue 312 and network services 314. Thus, suitable interface is provided for network based access to the controller 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. Network services 314 also advantageously supplies data interchange with client side services 320 for communication via FTP, electronic mail, TELNET, or the like. Thus, the controller function 300 facilitates output or receipt of electronic document and user information via various network access mechanisms.

Job queue 312 is also advantageously placed in data communication with an image processor 316. Image processor 316 is suitably a raster image process, page description language interpreter or any suitable mechanism for interchange of an electronic document to a format better suited for interchange with device services such as printing 304, facsimile 306 or scanning 308.

Finally, job queue 312 is in data communication with a parser 318, which parser suitably functions to receive print job language files from an external device, such as client device services 322. Client device services 322 suitably include printing, facsimile transmission, or other suitable input of an electronic document for which handling by the controller function 300 is advantageous. Parser 318 functions to interpret a received electronic document file and relay it to a job queue 312 for handling in connection with the afore-described functionality and components.

In operation, the client device 114 generates an electronic document, or image. In accordance with one aspect of the subject application, the electronic document is suitably formatted, defined, or encoded in any bitmapped, vectorized, specified page description language, or other suitable format. The electronic document is suitably generated for output in accordance with the ANSI formatting standards. For example, the output size is letter, ledger, legal, or the like. The client device 114 then transmits the electronic document to the client device 124 of the ISO region 104, or the document rendering device 118 of the ISO region 104 via the distributed communications environment 112. In order to output the received electronic document, the document must first be converted to an acceptable ISO format. For example, when the ANSI region 102 created document is letter, the corresponding ISO format is A4. In accordance with the subject application, when the client device 124 receives the electronic document from the ANSI region 102, the client device 124 forwards the document to the document rendering device 118 for output. Thus, discussion continues hereinafter from the perspective of the document rendering device 118.

Once the document rendering device 118 receives the document, the device 118 retrieves the region or country code with which it is associated. Thus, the device 118 determines that it is in an ISO region 104. The device 118 then determines the format of the received electronic document, in this case the ANSI region 102. The device 118 then ascertains whether or not the output size set by the electronic document is capable of being used. When the format is acceptable, i.e., the paper size is available on the document rendering device 118, the requested document processing operation is performed and a hardcopy of the document is output. When the document rendering device 118 determines that the output paper size required by the page formatting of the electronic document is not available, the device 118 resizes the electronic document automatically, based on the device's 118 region coding. Thus, when a ledger-sized document is received from the client device 114 of the ANSI region 102, the document rendering device 118 of the ISO region 104 alters the output size to the corresponding A3 paper size. It will be appreciated by those skilled in the art that such alteration of the output size of the received electronic document occurs automatically, i.e., without user intervention.

In accordance with one aspect of the subject application, the document rendering devices 106 and 118 are capable of performing two types of conversions on a received electronic document designating a paper format not supported by the document rendering device. The first such example conversion is a non-scaling conversion, which cuts off the print image of the document from the edge to fit onto the destination paper size. The skilled artisan will understand that such a conversion does not impact on the resolution of the output. That is, when a document is received at a 600 DPI resolution and is subjected to non-scaling conversion to the different paper size, the resolution remains at 600 DPI. For example a letter size image is wider than A4, therefore the ridge edge of a Letter size image being printed on A4 will be cut off. The second conversion type is a scaling conversion, whereupon the print image of the electronic document is resized to fit the destination paper size. The skilled artisan will appreciate that such a conversion necessitates a change in the resolution of the submitted electronic document.

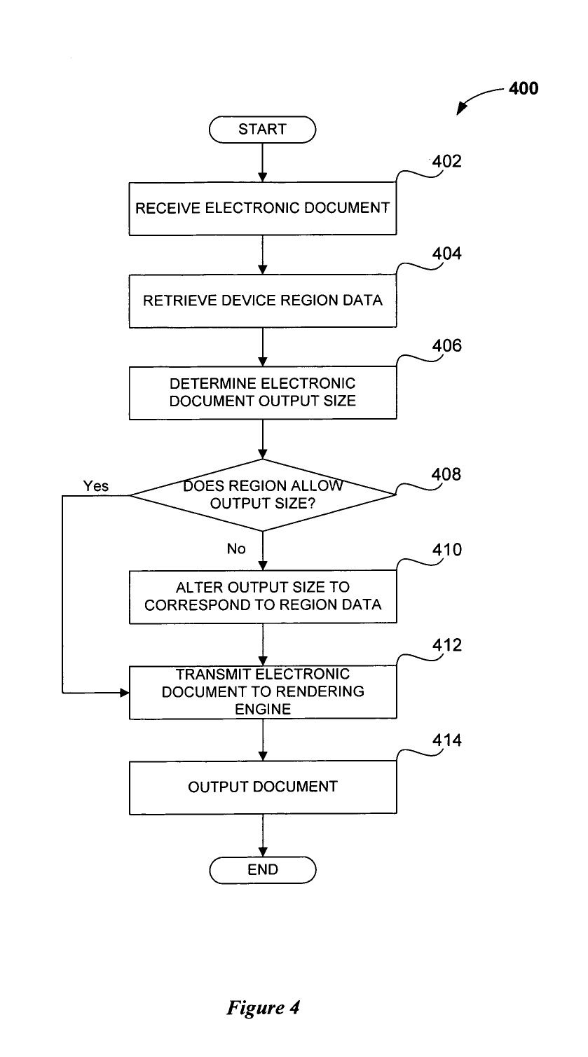

The skilled artisan will appreciate that additional embodiments are contemplated in accordance with the system 100 described above in FIGS. 1, 2, and 3, and in conjunction with the methodology illustrated in FIG. 4. As shown in FIG. 4, the flowchart 400 illustrates an example embodiment of the method contemplated in accordance with the subject application. Beginning at step 402, an electronic document is received by a document rendering device 118. For purposes of example only, reference will be made as the ISO region 104 receiving an electronic document from the ANSI region 102. It will be appreciated by the skilled artisan that the operations of the flowchart 400 are equally applicable in conversions from the ISO region 104 to the ANSI region 102, or from the regions 102 and 104 to or from a third region (not shown), such as, for example and without limitation, Chinese paper size regions. In the preferred embodiment, the received electronic document includes data representing its output paper size, print settings, and the like.

Following receipt of the electronic document, the document rendering device 118 retrieves its associated region data at step 404. Preferably, the region data includes data representative of the output standard used in the region, such as, for example and without limitation, ANSI, ISO, and the like. The document rendering device 118 then determines, at step 406, the original output paper size associated with the electronic document. When received from the ANSI region 102, the paper sizes include legal, statement, computer, letter, ledger, and the like. The document rendering device 118 then determines, at step 408, whether the device 118 is capable of outputting the requested paper size. It will be appreciated by those skilled in the art that the document rendering device 118 is capable of including a variety of paper trays, each containing a different output medium, such that the device 118 includes the ISO standard formats, and depending upon usage, a letter size supply of paper. Thus, when the document rendering device 118 is capable of outputting the requested paper size, flow proceeds to step 412, whereupon the electronic document is forwarded to the rendering engine of the document rendering device 118 and output at step 414. For example, the document rendering device 118 typically conducts transactions with ANSI devices, such that letter size output sheets are readily available, the device 118 then forwards the document to the rendering engine for output, without necessitating conversion.

When it is determined at step 408 that the document rendering device 118 is not capable of allowing the output of the electronic document in its original paper size, flow proceeds to step 410, whereupon the document output size is altered to correspond to the region 104 of the receiving document rendering device 118. Flow then proceeds to step 412, following conversion, whereupon the document is sent to the rendering engine and output at step 414. By way of example, when the received document is in legal size output format, the document rendering device converts the document to folio size for output. When the document is in statement paper size, it is converted to A5 paper size. Similarly, when the document received by the ISO region 104 document rendering device 118 is computer paper size, the document is altered at step 410 to the B4 paper size. When the paper size of the received document is 8K or 16K, according to Chinese output conventions, the document is converted at step 210 to the A3 or A4 paper sizes, respectively.

The skilled artisan will appreciate that a similar implementation of the flowchart 400 occurs with respect to the ANSI region 102 document rendering device 106 when an electronic document is received from, for example, the client device 124 at step 402. The document rendering device 106 then retrieves its regional data at step 404 and determines the output size of the received document at step 406. The device 106 then determines, at step 408, whether the requested document size is allowable for output. That is, when the output paper size is available, the document rendering device 106 forwards the document to the rendering engine at step 412 for output at step 414. When no such action is capable of being performed at step 408, flow proceeds to step 410, whereupon the received electronic document output size is altered to correspond to the ANSI region 102 paper sizes. For example, when a folio sized job is received by the document rendering device 106, it is altered to be output on legal size paper. Similarly, when an A5 document is received, it is altered for output on statement size paper. When a 16K document is received, the document rendering device 106 alters the electronic document so that it will be capable of output on letter size paper.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A method for automatically resizing electronic documents comprising the steps of:
receiving an electronic document;
testing region data representative of regional document output characteristics of an associated document rendering device;
determining an output size specified with a received electronic document;
selectively altering the received electronic document in accordance with tested region data and a determined output size so as to generate an output document; and
communicating a generated output document to the associated document rendering device.

2. The method for automatically resizing electronic documents of claim 1 wherein the step of selectively altering includes altering the received electronic document to reflect an output size corresponding to the region data and which approximates the output size.

3. The method for automatically resizing electronic documents of claim 2 wherein region data includes at least one of ISO and ANSI.

4. The method for automatically resizing electronic documents of claim 2 wherein the electronic document is encoded in a specified page description language.

5. The method for automatically resizing electronic documents of claim 2 wherein the electronic document is encoded in bitmapped form.

6. The method for automatically resizing electronic documents of claim 1 further comprising the step of determining whether the print size corresponds to the region data, wherein an output document is unchanged from a received electronic document upon a determination of such correspondence.

7. The method for automatically resizing electronic documents of claim 3 wherein the region data of the document rendering device is ISO and the output size includes folio size, A5 size, B4 size, A3 size, and A4 size.

8. The method for automatically resizing electronic documents of claim 3 wherein the region data of the document rendering size is ANSI and the output size includes legal size, statement size, computer size, ledger size, and letter size.

9. A system for automatically resizing electronic documents comprising:
means adapted for receiving an electronic document;
testing means adapted for testing region data representative of regional document output characteristics of an associated document rendering device;
determining means adapted for determining an output size specified with a received electronic document;
means adapted for selectively altering the received electronic document in accordance with tested region data and a determined output size so as to generate an output document; and
communication means adapted for communicating a generated output document to the associated document rendering device.

10. The system for automatically resizing electronic documents of claim 9 wherein means adapted for selectively altering the received electronic document further comprise means adapted for selectively altering the received electronic document to reflect an output size corresponding to the region data and which approximates the output size.

11. The system for automatically resizing electronic documents of claim 10 wherein region data includes at least one of ISO and ANSI.

12. The system for automatically resizing electronic documents of claim 10 wherein the electronic document is encoded in a specified page description language.

13. The system for automatically resizing electronic documents of claim 10 wherein the electronic document is encoded in bitmapped form.

14. The system for automatically resizing electronic documents of claim 9 further comprising means adapted for determining whether the print size corresponds to the region data, wherein an output document is unchanged from a received electronic document upon a determination of such correspondence.

15. The system for automatically resizing electronic documents of claim 11 wherein the region data of the document rendering device is ISO and the output size includes folio size, A5 size, B4 size, A3 size, and A4 size.

16. The system for automatically resizing electronic documents of claim 11 wherein the region data of the document rendering size is ANSI and the output size includes legal size, statement size, computer size, ledger size, and letter size.

17. A computer-implemented method for automatically resizing electronic documents comprising the steps of:
receiving an electronic document;
testing region data representative of regional document output characteristics of an associated document rendering device;
determining an output size specified with a received electronic document;
selectively altering the received electronic document in accordance with tested region data and a determined output size so as to generate an output document; and
communicating a generated output document to the associated document rendering device.

18. The computer-implemented method for automatically resizing electronic documents of claim 17 wherein the step of selectively altering includes altering the received electronic document to reflect an output size corresponding to the region data and which approximates the output size.

19. The computer-implemented method for automatically resizing electronic documents of claim 18 wherein region data includes at least one of ISO and ANSI.

20. The computer-implemented method for automatically resizing electronic documents of claim 19 further comprising the step of determining whether the print size corresponds to the region data, wherein an output document is unchanged from a received electronic document upon a determination of such correspondence.
